(19) United States
(12) Patent Application Publication
(10) Pub. No.: US 2006/0125720 A1
(43) Pub. Date: Jun. 15, 2006

(54) Plasma display device

(75) Inventors: Sok-San Kim, Cheonan-si (KR); Tae-Kyoung Kang, Asan-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/289,444

(22) Filed: Nov. 30, 2005

(30) Foreign Application Priority Data
Dec. 9, 2004 (KR) 10-2004-0103645
Jun. 15, 2005 (KR) 10-2005-0051361

(51) Int. Cl. G09G 3/28

(52) U.S. Cl. 345/60

(57) ABSTRACT

There is provided a plasma display device including a panel displaying an image, a frame supporting the panel, a driving unit coupled with the frame to generate electrical signals for driving the panel, and a signal transferring unit including at least one signal transferring line for transferring electrical signals between the driving unit and the panel, and at least one ground line having a ground portion connected to the driving unit and electrically connected to the frame.

### CROSS-REFERENCE TO RELATED PATENT APPLICATIONS

This application claims priority to and the benefit of Korean Patent Application No. 10-2004-0103645, filed on Dec. 9, 2004, and Korean Patent Application No. 10-2005-0051361, filed on Jun. 15, 2005, which are hereby incorporated by reference for all purposes as if fully set forth herein.

### BACKGROUND OF THE INVENTION

1. Field of the Invention

The present invention relates to a plasma display device that displays images using gas discharge, and more particularly, to a plasma display device having a signal transfer unit to transfer electrical signals between a plasma display panel and its driver.

2. Discussion of the Background

Generally, a plasma display device is a thin and lightweight flat panel display that displays images using gas discharge. The plasma display device may have high definition and a wide viewing angle, and compared with other flat panel displays, it may be easily manufactured with a large screen, making it the next-generation choice for large flat panel displays.

The plasma display device may include a plasma display panel (PDP), a driving unit, and a signal transferring unit. The PDP displays an image by exciting a phosphor using ultraviolet radiation generated by gas discharge. The driving unit drives the PDP to display an image corresponding to an external image signal. The signal transferring unit manages the transfer of electrical signals between the PDP and the driving unit.

Specifically, the signal transferring unit may have an integrated circuit (IC) chip for controlling, at a high speed, a driving signal transferred to the PDP, such as an alternating current (AC) electrical signal. Therefore, noise and electromagnetic interference may be generated when driving the PDP. Such noise and electromagnetic interference should be removed to provide more reliable operation of the plasma display device.

For this purpose, in the conventional plasma display device, one of a plurality of lines connecting the PDP and the driving unit may be grounded. This ground line is connected to the driving unit of the PDP, and the driving unit is connected to a chassis that supports the PDP and has a ground potential. In this manner, the conventional plasma display device may reduce the noise and electromagnetic interference.

However, since the ground line is connected to the chassis through a complicated path, the noise and electromagnetic interference may not be removed sufficiently.

Further, when the content of xenon gas contained in discharge gas is increased to improve the plasma display device's efficiency, the voltage needed to initiate or sustain the discharge also increases. Therefore, such a conventional structure has a limitation in removing the noise and electromagnetic interference.

### SUMMARY OF THE INVENTION

The present invention provides a plasma display device that may improve driving reliability by reducing noise and electromagnetic interference generated during the device's operation.

The present invention also provides a plasma display device that may improve driving reliability by preventing noise and electromagnetic interference from increasing when the voltage applied for discharge increases.

Additional features of the invention will be set forth in the description which follows, and in part will be apparent from the description, or may be learned by practice of the invention.

The present invention discloses a plasma display device including a panel displaying an image, a frame supporting the panel, a driving unit coupled with the frame to generate electrical signals for driving the panel, and a signal transferring unit including at least one signal transferring line for transferring electrical signals between the driving unit and the panel, and at least one ground line having a ground portion connected to the driving unit and electrically connected to the frame.

The present invention also discloses a plasma display device including a panel displaying an image, a frame supporting the panel, a driving unit coupled with the frame to generate electrical signals for driving the panel, a signal transferring unit including at least one signal transferring line for transferring electrical signals between the driving unit and the panel, and at least one ground line having a ground portion connected to the driving unit and electrically connected to the frame, and a fixing member fixing the ground portion such that the ground portion is electrically connected to the frame.

The present invention also discloses a plasma display device including a panel displaying an image, a frame supporting the panel, a driving unit coupled with the frame to generate electrical signals for driving the panel, a signal transferring unit including at least one signal transferring line for transferring electrical signals between the driving unit and the panel, and at least one ground line having a ground portion connected to the driving unit and electrically connected to the frame, a cover plate covering at least a part of the ground portion, and a first fixing member passing through the cover plate and connected to the frame, such that the ground portion is electrically connected to the frame.

The present invention also discloses a plasma display device including a panel displaying an image, a frame supporting the panel, a driving unit coupled with the frame to generate electrical signals for driving the panel, a signal transferring unit including at least one signal transferring line for transferring electrical signals between the driving unit and the panel, and at least one ground line having a ground portion connected to the driving unit and electrically connected to the frame, and a cover plate covering at least a part of the ground portion so as to electrically connect the ground portion to the frame.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exploded perspective view of a plasma display device according to a first exemplary embodiment of the present invention.

FIG. 2 is a sectional view of a signal transferring unit in the plasma display device of FIG. 1.

FIG. 3 is a plan view of the signal transferring unit of FIG. 1.

FIG. 4 is a sectional view of the signal transferring unit of FIG. 1.

FIG. 5 and FIG. 6 are plan views of modifications of the signal transferring unit of FIG. 1.

FIG. 7 is a sectional view of a signal transferring unit according to a second exemplary embodiment of the present invention.

FIG. 8 is a sectional view of a signal transferring unit according to a third exemplary embodiment of the present invention.

FIG. 9 is a sectional view of a signal transferring unit according to a fourth exemplary embodiment of the present invention.

FIG. 10 is a perspective view of the signal transferring unit of FIG. 9.

FIG. 11 is a sectional view of the signal transferring unit of FIG. 9.

FIG. 12 is a sectional view of a signal transferring unit according to a fifth exemplary embodiment of the present invention.

FIG. 13 is a sectional view of a signal transferring unit according to a sixth exemplary embodiment of the present invention.

FIG. 14 is a sectional view of a signal transferring unit according a seventh exemplary embodiment of the present invention.

### DETAILED DESCRIPTION OF THE ILLUSTRATED EMBODIMENTS

Hereinafter, exemplary embodiments of the present invention will be described in detail with reference to the accompanying drawings.

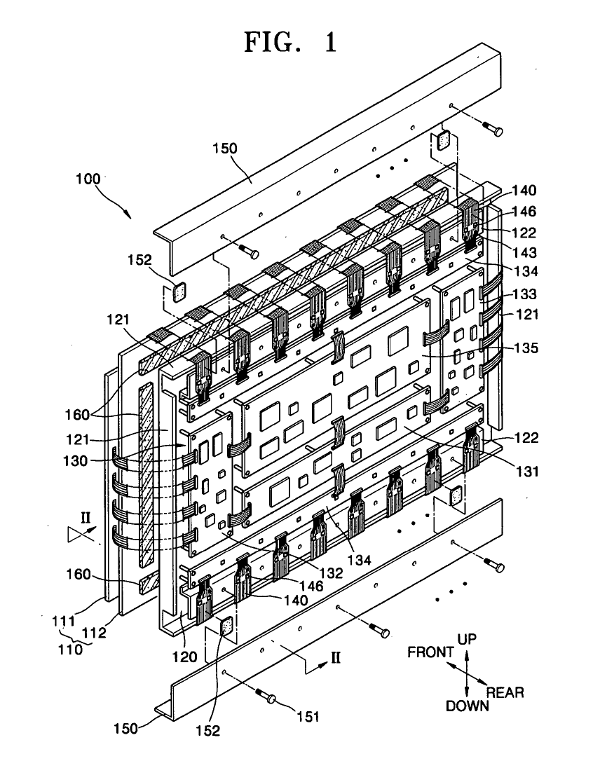

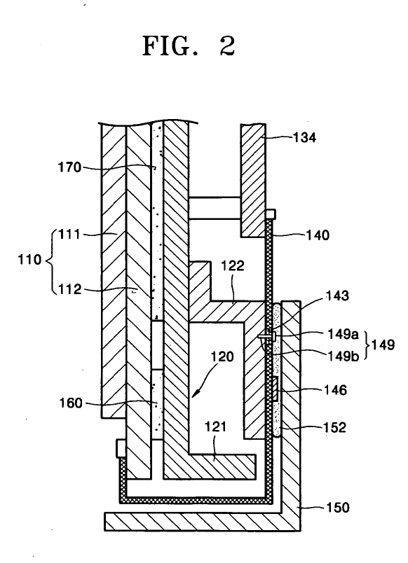

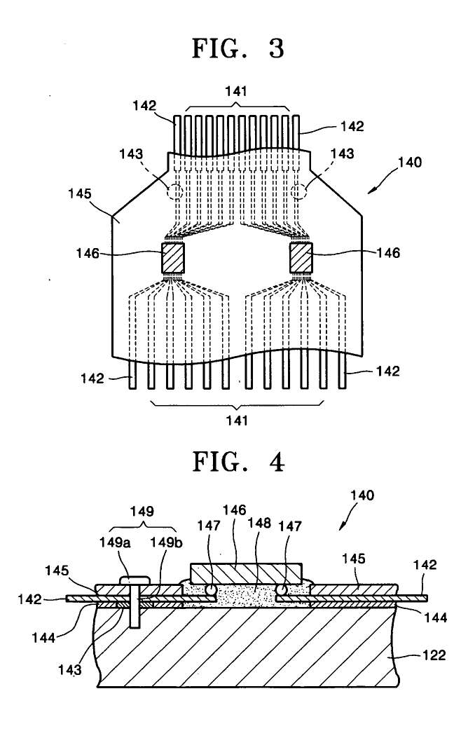

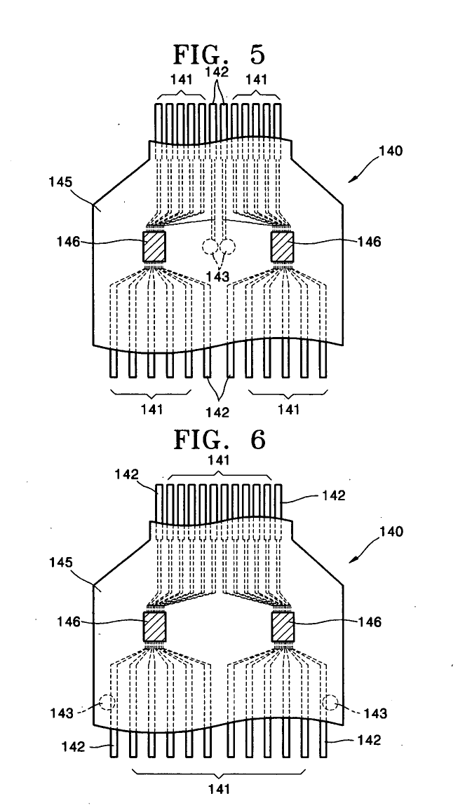

FIG. 1 is an exploded perspective view of a plasma display device according to a first exemplary embodiment of the present invention, FIG. 2 is a sectional view of a signal transferring unit in the plasma display device of FIG. 1, FIG. 3 is a plan view of the signal transferring unit of FIG. 1, FIG. 4 is a sectional view of the signal transferring unit of FIG. 1, and FIG. 5 and FIG. 6 are plan views of modifications of the signal transferring unit of FIG. 1.

Referring to FIG. 1, FIG. 2, FIG. 3 and FIG. 4, the plasma display device according to the first exemplary embodiment of the present invention includes a panel 110, a frame 120, a driving unit 130, and a signal transferring unit 140.

The panel 110 includes a front panel 111 and a rear panel 112 that are spaced apart from each other and facing each other. A discharge space is formed between the front panel 111 and the rear panel 112.

Although not shown, barrier ribs may partition the discharge space into a plurality of discharge cells, and a discharge gas is injected into the discharge cells. When an electric field is applied to the discharge cells, the discharge gas discharges to generate plasma and produce ultraviolet radiation. Also, phosphors are formed in the discharge cells, and the ultraviolet radiation from the discharge gas causes the phosphors to emit light.

A plurality of electrodes are provided at the front panel, the rear panel, or the barrier ribs. The plurality of electrodes form an electric field to cause discharge in the discharge cells. These electrodes may have various arrangements. For example, first and second electrodes may be formed on the front panel and the rear panel, respectively, crossing each other. Alternatively, first and second sustain discharge electrodes may be formed opposing each other on the front panel, and a third electrode, for selecting a discharge cell, may be formed on the rear panel. In the case of a tri-electrode surface discharge PDP, a plurality of scan electrodes and a plurality of sustain electrodes are alternately arranged in parallel on the front panel, and a plurality of address electrode lines are formed on the rear panel in a direction crossing the scan and sustain electrodes. Portions of the discharge space corresponding to crossings of a scan and sustain electrode pair and an address electrode correspond to the respective discharge cells.

Terminals of the electrodes are arranged along the edges of the front panel or the rear panel. The electrode terminals are coupled with the signal transferring unit 140 to receive the driving signals for driving the panel 110 from the driving unit 130.

The frame 120 is coupled with the rear of the panel 110 and supports the panel 110. As shown in FIG. 1, an adhesive member such as a strip of double-sided tape 160 may couple the frame 120 with the panel 110. The frame 120 may be formed in a plate shape to correspond to the panel 110, and is made of a rigid material, such as metal, for stably supporting the panel 110.

In order to increase the frame's rigidity, portions 121 bent away from the rear of the panel 110 are formed at the edges of the frame 120. Further, since the frame 120 may be thin and lightweight, reinforcing members 122 may be arranged on the frame 120 to increase its rigidity. For example, the reinforcing members 122 may be coupled with the frame 120 by welding, screws or bosses.

A heat conduction medium 170 having good heat conductivity may be arranged between the frame 120 and the panel 110. When the panel 110 generates heat during operation of the plasma display device 100, the heat conduction medium 170 may transfer heat to the frame 120 so that it may be dissipated outside the device. In order to increase heat conductivity, the heat conduction medium 170 may be arranged at a central portion of the panel 110, and the double-sided tape 160 may be arranged in the vicinity of the heat conduction medium 170.

The driving unit 130 is located behind the frame 120. The driving unit 130 may include an image processor/logic controller 131, electrode drivers 132, 133 and 134, and a power supply 135. The image processor/logic controller 131 converts an external image signal into an internal image signal and processes the internal image signal to output a plurality of electrode control signals. The electrode drivers, including a scan electrode driver 132, a sustain electrode driver 133 and an address electrode driver 134, generate driving signals for the scan electrodes, the sustain electrodes and the address electrodes, respectively, according to the corresponding electrode control signals input from the image processor/logic controller 131. The power supply 135 supplies the image processor/logic controller 131 and the electrode drivers 132, 133 and 134 with various voltages. Specifically, the power supply 135 supplies the scan electrode driver 132, the sustain electrode driver 133 and the address electrode driver 134 with various voltages used to apply the respective driving signals to the scan electrodes, the sustain electrodes, and the address electrodes.

In the case of the tri-electrode surface discharge plasma display device, one frame may be divided into a plurality of sub-fields, and one sub-field may be divided into a reset period, an address period, and a sustain period. During the reset period, a reset pulse may be applied to the scan electrodes to perform a reset discharge that initializes all discharge cells. During the address period, a scan pulse may be sequentially applied to the scan electrodes to perform an address discharge to select cells to be discharged. Also, a display data signal corresponding to the scan pulse is applied to the address electrodes. During the sustain period, a sustain pulse may be alternately applied to the scan electrodes and the sustain electrodes to perform a sustain discharge in the selected discharge cells.

The signal transferring unit 140 transfers driving signals between the panel 110 and the driving unit 130. For example, in the case of the tri-electrode surface discharge plasma display device, the signal transferring unit 140 transfers the driving signals output from the scan electrode driver 132, the sustain electrode driver 133 and the address electrode driver 134 to the scan electrodes, the sustain electrodes and the address electrodes, respectively, of the panel 110. Accordingly, as shown in FIG. 1 and FIG. 2, one end of the signal transferring unit 140 is coupled with edges of the panel 110 where electrode terminals are arranged, and the other end of the signal transferring unit 140 is coupled with the electrode drivers 132, 133 and 134, which are arranged near the edges of the frame 120. As a whole, the signal transferring unit 140 is arranged to substantially surround the edges of the frame 120. The signal transferring unit 140 may have various forms, such as a flexible printed cable (FPC) or a tape carrier package (TCP).

For example, FIG. 3 and FIG. 4 show a TCP type signal transferring unit 140. Referring to FIG. 3 and FIG. 4, the TCP signal transferring unit 140 has one end coupled with the electrodes of the panel 110 and the other end coupled with the electrode drivers 132, 133 and 134 of the driving unit 130. The TCP signal transferring unit 140 includes a plurality of signal transferring lines 141 that manage the transfer of electrical signals, such as the reset pulse, the scan pulse, the display data signal, and the sustain pulse, between the electrode drivers 132, 133 and 134 and the electrodes of the panel 110. Except for their ends, the signal transferring lines 141 are arranged in a pattern on an insulating layer 144 and are coated with another insulating layer 145. Accordingly, the insulating layers 144 and 145 insulate portions of the signal transferring lines 141 from the outside. Both ends of the signal transferring lines 141 are not coated with the insulating layers 144 and 145 so that they may couple the electrodes of the panel 110 with the electrode drivers 132, 133 and 134 of the driving unit 130. Also, an integrated circuit (IC) chip 146 is coupled with the signal transferring lines 141. The IC chip 146 has circuits to control the transfer of electrical signals, such as the reset pulse, the scan pulse, the display data signal and the sustain pulse, between the panel 110 and the driving unit 130. Alternatively, the IC chip 146 may be provided on the driving unit 130 instead of the signal transferring unit 140. The IC chip 146 is coupled with the signal transferring lines 141 by an adhesive such as a bump 147, and the connection is coated with an epoxy resin 148.

The signal transferring unit 140 includes ground lines 142, and each ground line 142 includes a ground portion 143 substantially contacting with the frame 120. As shown in FIG. 4, after partially exposing a ground line 142, the ground portion 143 may be formed on the exposed region. The ground portion 143 is wider than other portions of the ground line 142 or the signal transferring line 141. Also, the entire ground line 142 may be used as the ground portion 143, such that the ground line 142 is wider than the signal transferring line 141. Alternatively, the ground portion 143 may be formed on an upper portion of the ground line 142. Specifically, a portion of the insulating layer 145 covering the ground line 142 may be removed to partially expose the upper portion of the ground line 142, and the ground portion 143 may be formed on the exposed portion. Furthermore, the ground portion 143 may be formed on both upper and lower sides of the ground line 142, by removing portions of the insulating layers 144 and 145 to expose the ground line 142. The signal transferring unit 140 may include one or more ground lines 142, and one or more ground portions 143 may be formed on each ground line 142. The ground portion 143 and the ground line 142 are conductive, and the ground portion 143 may be formed of the same material as the ground line 142. As FIG. 3 shows, the ground portion 143 may be located at an upper edge of the signal transferring unit 140. Also, FIG. 5 and FIG. 6 show, the ground portion 143 may be located at a central portion or a lower edge of the signal transferring unit 140, respectively.

As shown in FIG. 2 and FIG. 4, the ground portion 143 substantially contacts with the reinforcing member 122 of the frame 120. A fixing pin 149, which passes through the signal transferring unit 140, fixes the ground portion 143 to the reinforcing member 122. Since the fixing pin 149 fixes the ground portion 143 to the reinforcing member 122 while passing through the ground portion 143, their electrical connection may be ensured. The fixing pin 149 may be conductive. The fixing pin's influence on the ground line 142 may be reduced when the insulating layer 145 is arranged between a head 149a of the fixing pin 149 and the ground line 142. In an alternative configuration, a through-hole, through which a main body 149b of the fixing pin 149 is inserted, perforates a region other than the signal transferring line 141 or the ground line 142, a head portion 149a of the fixing pin 149 presses the ground portion 143 onto the reinforcing member 122 such that the ground portion 143 substantially contacts with the reinforcing member 122. In this case, the fixing pin 149 is preferably nonconductive. Accordingly, negative effects of a conductive fixing pin 149 on the signal transferring line 141 or the ground line 142 may be minimized.

The ground portion 143 may substantially contact with the reinforcing member 122 through a conductive adhesive. The ground portion's surface facing the reinforcing member 122 is not coated with the insulating layer 144, while portions of the upper surface of the ground portion 143 are coated with the insulating layer 145. In this case, the ground portion 143 and the reinforcing member 122 may electrically contact each other without using the fixing pin 149. In order to ensure secure substantial contacting, the ground portion 143 may be attached to the reinforcing member 122 using a conductive adhesive, and the fixing pin 149 may be further provided to press the ground portion 143.

A heat sink plate 150 is installed on the signal transferring unit 140. The heat sink plate 150 protects the ground portion 143 and the IC chip 146, and it helps dissipate heat generated by the signal transferring unit 140 to the outside. By bending the heat sink plate 150 to surround the edges of the frame 120, the overall volume of the plasma display device may be reduced, the signal transferring unit 140 is protected, and the heat from the signal transferring unit 140 may be easily dissipated. The heat sink plate 150 may cover the ground portion 143, the IC chip 146, or the ground portion 143 and the IC chip 146. As shown in FIG. 1, the heat sink plate 150 may be fixed to the reinforcing member 122 by a separate fixing member such as a bolt 151. A heat conduction medium 152 is provided between the heat sink plate 150 and the signal transferring unit 140. Including the heat conduction medium 152 helps smoothly transfer heat from the signal transferring unit 140 to the heat sink plate 150.

In the plasma display device 100 according to the first exemplary embodiment of the present invention, the driving unit 130 receives the external image signal and applies electrical signals, such as the reset pulse, the scan pulse, the display data signal and the sustain pulse, to the electrodes of the panel 110 through the signal transferring unit 140. Noise and electromagnetic interference generated during this procedure may be significantly reduced by the signal transferring unit's ground portion 143, which substantially contacts with the grounded frame, thereby providing more stable and reliable driving of the plasma display device 100.

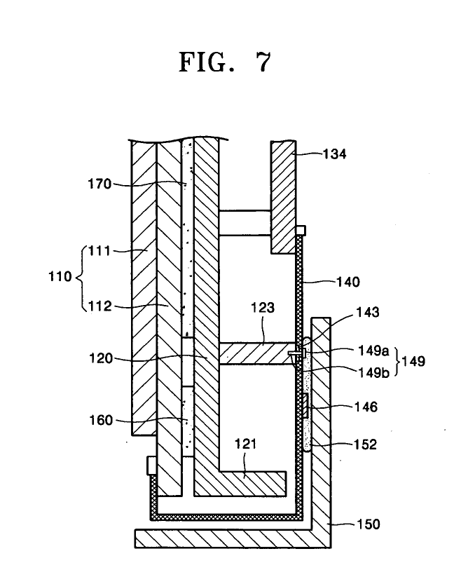

FIG. 7 is a sectional view of a signal transferring unit in a plasma display device according to a second exemplary embodiment of the present invention.

The plasma display device of the second exemplary embodiment is similar to the plasma display device 100 of the first embodiment. One difference is that the ground portion 143 substantially contacts with a boss 123, rather than the reinforcing member 122. In FIG. 7, elements common to FIG. 1 through FIG. 4 are assigned the same reference numerals.

Referring to FIG. 7, the ground portion 143 substantially contacts with the boss 123, which is coupled with the frame 120. The ground portion 143 is located on the boss 123. Since a fixing pin 149 passes through the ground portion 143, the ground portion 143 may be closely attached to the boss 123, thus substantially contacting the ground portion 143 with the boss 123. A head portion 149a of the fixing pin 149 presses the insulating layer 145 coating the ground portion 143 as shown in FIG. 4, such that the ground portion 143 may be closely attached to the boss 123. The main body 149b of the fixing pin 149 passes through the ground portion 143 and is coupled with the boss 123, such that the fixing pin 149 is coupled with the boss 123. In this case, the ground portion 143 may be attached to the boss 123 using a conductive adhesive before being fixed by the fixing pin 149.

Alternatively, the ground portion 143 may be attached to the boss 123 by a conductive adhesive instead of the fixing pin 149. In this case, the fixing pin 149 is unnecessary.

The boss 123 is made of a conductive material such as a metallic material. The boss 123 may be coupled with the frame 120 by a screw, for example.

Unlike the first embodiment, the heat sink plate 150 is fixed to the frame 120, not to the reinforcing member 122.

According to the second embodiment, the ground portion 143 may be easily coupled with the frame 120 by the boss 123, which has a simpler structure than the reinforcing member 122.

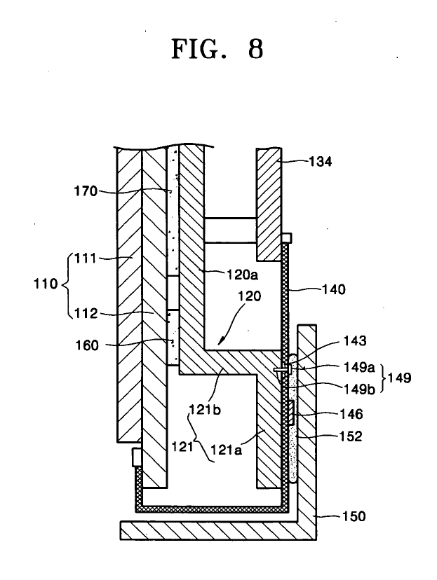

FIG. 8 is a sectional view of a signal transferring unit in a plasma display device according to a third exemplary embodiment of the present invention.

The plasma display device of the third embodiment is similar to the plasma display device 100 of the first embodiment. One difference is that the ground portion 143 substantially contacts with a bent portion 121 of the frame 120 rather than the reinforcing member 122. In FIG. 8, elements common to FIG. 1 through FIG. 4 are assigned the same reference numerals.

Referring to FIG. 8, the ground portion 143 substantially contacts with the bent portion 121 of the frame 120. The bent portion 121 includes a first bent portion 121a substantially contacting with the ground portion 143, and a second bent portion 121b connecting the first bent portion 121a to the frame's main body 120a, which is attached to the panel 110. The first and second bent portions 121a and 121b are coupled with the main body 120a of the frame 120 as one body. A surface of the first bent portion 121a on which the signal transferring unit 140 is located may protrude slightly above a surface on which the signal transferring unit 140 of the electrode drivers 132, 133 and 134 is located. Due to this construction, the ground portion 143 may substantially contact with the first bent portion 121a without damaging the signal transferring unit 140. As shown in FIG. 8, in order to connect the first bent portion 121a and the main body 120a of the frame 120, the second bent portion 121b may be bent and protrude vertically from the main body 120a of the frame 120. However, the bent portion 121 may have various configurations.

Since the interface between the ground portion 143 and the first bent portion 121a is similar to that of the ground portion 143 and the reinforcing member 122 in the first embodiment, a detailed description thereof will be omitted.

According to the third embodiment, the ground portion 143 may substantially contact with the frame 120 without adding a separate member.

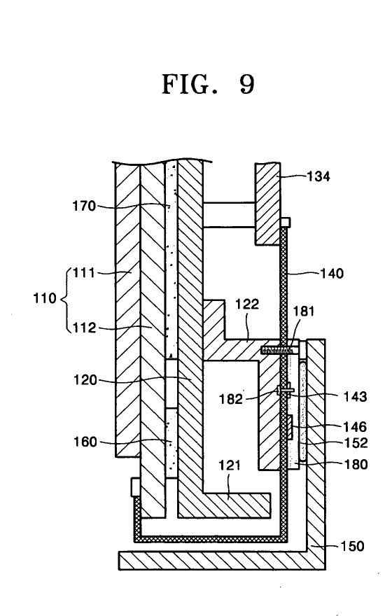

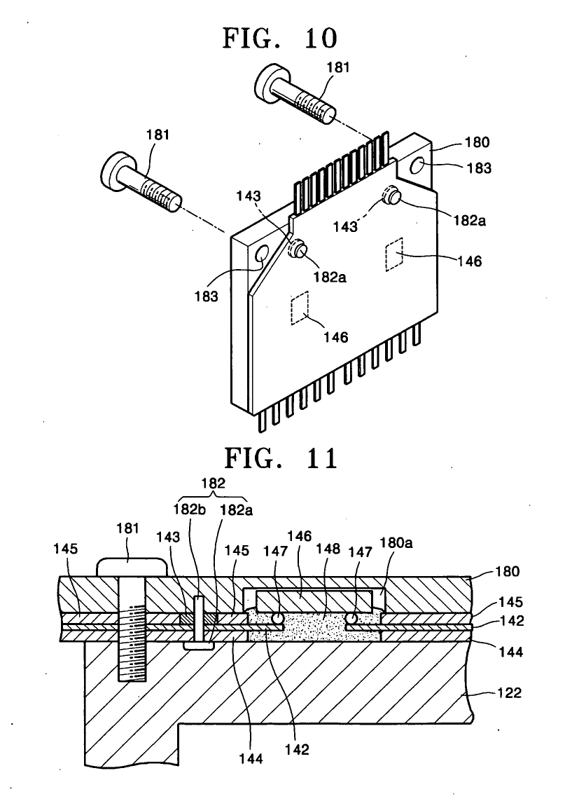

FIG. 9 is a sectional view of a signal transferring unit according to a fourth exemplary embodiment of the present invention, FIG. 10 is a perspective view of the signal transferring unit of FIG. 9, and FIG. 11 is a sectional view of the signal transferring unit of FIG. 9.

The plasma display device of the fourth embodiment is similar to the plasma display device 100 of the first embodiment. One difference is that a cover plate 180 is further provided on the signal transferring unit 140. In FIG. 9 through FIG. 11, elements common to FIG. 1 through FIG. 4 are assigned the same reference numerals.

Referring to FIG. 9, FIG. 10, and FIG. 11, a reinforcing member 122 is arranged on the frame 120, and a signal transferring unit 140 is located at the reinforcing member 122. The cover plate 180 faces the reinforcing member 122, and the signal transferring unit 140 is arranged between the cover plate 180 and the reinforcing member 122. The cover plate 180 is coupled with the reinforcing member 122 by a fixing member such as a bolt 181.

The ground portion 143 of the signal transferring unit 140 substantially contacts with the cover plate 180. In order to ensure the substantial contacting between the ground portion 143 and the cover plate 180, the fixing pin 182 passes through the ground portion 143. As shown in FIG. 11, a head 182a of the fixing pin 182 is arranged to face the reinforcing member 122 and may be substantially the same size or smaller than that of the ground portion 143. The main body 182b of the fixing pin 182 passes through the insulating layer 144, the ground line 142 and the ground portion 143, and is coupled with the cover plate 180. The head 182a of the fixing pin 182 may substantially contact with the reinforcing member 122. The main body 182b of the fixing pin 182 may pass through only the ground portion 143, without passing through the ground line 142. The main body 182b of the fixing pin 182 may penetrate the cover plate 180.

The ground portion 143 of the signal transferring unit 140 may be attached to the cover plate 180 by a conductive adhesive. Alternatively, the ground portion 143 may be attached to the cover plate 180 by arranging the signal transferring unit 140 such that the ground portion 143 is located between the cover plate 180 and the reinforcing member 122, and then properly adjusting the bolt 181 coupling the cover plate 180 with the reinforcing member 122. In this case, a separate member such as the fixing member 182 may be omitted.

As shown in FIG. 11, for the substantial contacting between the ground portion 143 and the cover plate 180, a part of the insulating layer 145 where the ground portion 143 is to be formed may be removed. Also, the ground portion 143 may be formed between the cover plate 180 and the ground line 142. However, the present invention is not limited to this structure. For example, the ground portion 143 may be formed between the reinforcing member 122 and the ground line 142, so that the ground portion 143 may substantially contact with the reinforcing member 122 rather than the cover plate 180. Further, by forming the ground portion 143 on both sides of ground line 142, the ground portion 143 may substantially contact with both the cover plate 180 and the reinforcing member 122.

A groove 180a is formed in the cover plate 180. The groove 180a is sized to accommodate the IC chip 146 so that the cover plate 180 may be closely attached to the signal transferring unit 140 without damaging the IC chip 146. This construction may be applied to the case where the IC chip 146 is arranged facing toward the cover plate 180. On the other hand, if the IC chip 146 is arranged facing toward the reinforcing member 122, a groove is formed in the is reinforcing member 122 to accommodate the IC chip 146.

As shown in FIG. 10, the bolt 181 fixing the cover plate 180 to the reinforcing member 122 need not pass through the signal transferring unit 140, which may prevent the bolt 181 from negatively affecting the signal transferring unit 140. To improve the attachment between the cover plate 180 and the signal transferring unit 140, the fixing member such as the bolt 181 may pass through a region away from the signal transferring line 141 and the ground line 142. As shown in FIG. 10, a screw hole 183 corresponding to the bolt 181 is formed in the cover plate 180.

The reinforcing member 122 has a hole into which the bolt 181 may be inserted. The reinforcing member 122, the bolt 181 and the cover plate 180 are made of a conductive material such as a metallic material.

According to the fourth embodiment of the present invention, the substantial contacting between the ground portion 143 and the frame 120 may be ensured, and the noise and electromagnetic interference may be greatly reduced.

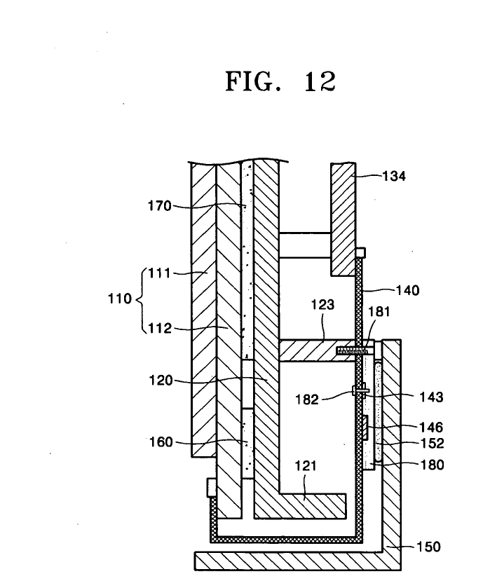

FIG. 12 is a sectional view of a signal transferring unit in a plasma display device according to a fifth exemplary embodiment of the present invention.

The plasma display device of the fifth embodiment is similar to the plasma display device of the fourth embodiment. One difference is that the cover plate 180 is coupled with the boss 123, rather than the reinforcing member 122. In FIG. 12, elements common to FIG. 9, FIG. 10 and FIG. 11 are assigned the same reference numerals.

Referring to FIG. 12, the boss 123 is coupled with the frame 120 and the cover plate 180 is coupled with the boss 123 by a fixing member such as the bolt 181. A hole is formed along the length of the boss 123, and the bolt 181 is coupled with the hole. Like the plasma display device of the fourth embodiment shown in FIG. 9 through FIG. 11, the ground portion 143 of the signal transferring unit 140 substantially contacts with the cover plate 180 through the fixing pin 182.

According to the fifth embodiment of the present invention, the ground portion 143 of the signal transferring unit 140 may be easily grounded to the frame 120 by a simple member such as the boss 123. Also, since the surface of the signal transferring unit 140 opposite the cover plate 180 may be directly exposed to air, the heat radiation efficiency of the signal transferring unit 140 may improve.

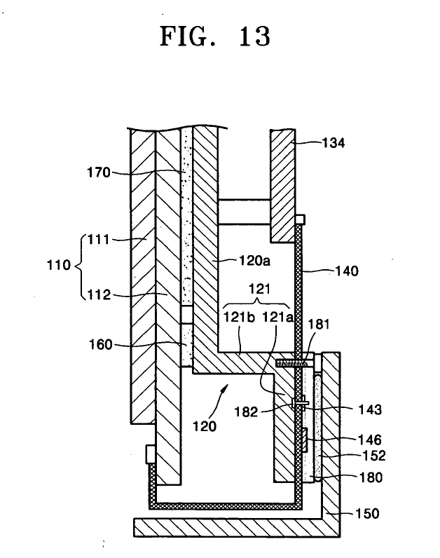

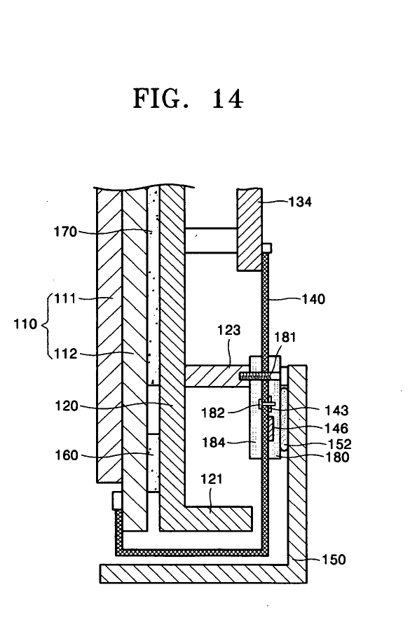

FIG. 13 is a sectional view of a signal transferring unit in a plasma display device according to a sixth exemplary embodiment of the present invention.

The plasma display device of the sixth embodiment is similar to the plasma display device of the fourth embodiment. One difference is that the cover plate 180 is coupled with the bent portion 121 of the frame, rather than the reinforcing member 122. In FIG. 13, elements common to FIG. 9, FIG. 10, and FIG. 11 are assigned the same reference numerals.

Referring to FIG. 13, the bent portion 121 of the frame 120 includes a first bent portion 121a substantially contacting the signal transferring unit 140, and a second bent portion 121b connecting the first bent portion 121a and the main body 120a of the frame 120. The first and second bent portions 121a and 121b and the main body 120a of the frame 120 form one body. The first bent portion's surface where the signal transferring unit 140 is arranged is equal to, or slightly protruded from, the electrode driver's 134 surface where the signal transferring unit 140 is arranged. In this case, the signal transferring unit 140 may be closely attached to the first bent portion 121a. The second bent portion 121b protrudes vertically from the first bent portion 121a and the main body 121a. However, the present invention is not limited to this construction.

Since the connecting structure between the cover plate 180 and the first bent portion 121a is almost the same as that between the cover plate 180 and the reinforcing member 122 in the fourth embodiment, a detailed description thereof will be omitted.

According to the sixth embodiment of the present invention, the cover plate 180 is coupled with the frame 120 without adding a separate member such as the reinforcing member as in the fourth embodiment, thereby simplifying the structure and reducing time of the manufacturing process.

FIG. 14 is a sectional view of a signal transferring unit in a plasma display device according to a seventh exemplary embodiment of the present invention.

The plasma display device of the seventh embodiment is similar to the plasma display device of the fifth embodiment. One difference is that the signal transferring unit 140 is supported by a support plate 184 coupled with the boss 123. In FIG. 14, elements common to FIG. 12 are assigned the same reference numerals.

Referring to FIG. 14, the boss 123 has one end coupled with the frame 120 and the other end coupled with the support plate 184. The support plate 184 has a larger cross-sectional area than the boss 123, and it supports the signal transferring unit 140. The support plate 184 has a region connected to the boss 123, and it extends to support the ground portion 143 of the signal transferring unit 140 and the IC chip 146. The support plate 184 is coupled with the boss 123 by a fixing member such as the bolt 181. This may be the same or a different bolt 181 as the bolt coupling the cover plate 180 to the boss 123.

Since the other elements of the seventh embodiment are substantially the same as those of the fifth embodiment, a detailed description thereof will be omitted. However, unlike is the fifth embodiment, the ground portion 143 of the signal transferring unit 140 may substantially contact with the support plate 184, rather than the cover plate 180. Further, the ground portion 143 may substantially contact with both the cover plate 180 and the support plate 184. Since this construction may be easily understood based on the fourth embodiment, a detailed description thereof will be omitted.

Unlike the fifth embodiment shown in FIG. 12, the signal transferring unit 140 is supported by the support plate 184 and covered by the cover plate 180, thereby ensuring the substantial contacting between the frame 120 and the ground portion 143.

The operation of a plasma display device according to an embodiment of the present invention will now be described. The driving unit 130 receives the external image signal and generates signals for driving the panel 110. The driving signals are transferred to the panel 110 through the signal transferring unit 140. The panel 110 receives the electrical signals from the signal transferring unit 140 and generates discharges. The phosphor is excited by the ultraviolet radiation from the discharges, and visible rays are emitted to the front of the panel 110, thereby displaying the image. However, noise or electromagnetic interference, which is generated during these procedures, may be rapidly removed through the ground portion 143 that substantially contacts with the grounded frame 120. Consequently, the plasma display device may be driven stably and reliably.

In order to increase the plasma display device's efficiency, the content of xenon (Xe) contained in the discharge gas may be increased. In this case, a high voltage is applied to initiate or sustain the discharge. Since the intensity of the electrical signals increases, the problem of noise and electromagnetic interference may become more serious. Accordingly, removal of the noise or electromagnetic interference is important. According to embodiments of the present invention, the noise and electromagnetic interference may be greatly reduced, and the plasma display device may be driven stably and reliably.

The plasma display device of the present invention may have the following advantages.

First, the driving stability and reliability may be increased because noise and electromagnetic interference may be significantly reduced.

Second, even when using discharge gas with a high xenon content, which requires a higher voltage for discharge, noise and electromagnetic interference may be significantly reduced, thereby providing high efficiency and stable, reliable operation.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display device, comprising:
a panel displaying an image;
a frame supporting the panel;
a driving unit coupled with the frame to generate electrical signals for driving the panel; and
a signal transferring unit comprising at least one signal transferring line and at least one ground line,
wherein the at least one signal transferring line transfers electrical signals between the driving unit and the panel, and
wherein the at least one ground line comprises a ground portion substantially contacting with the frame.

2. The plasma display device of claim 1, wherein the signal transferring unit further comprises an integrated circuit chip coupled with the at least one signal transferring line to control transfer of the electrical signals between the driving unit and the panel, and
wherein at least a portion of the at least one signal transferring line is coated with an insulating layer.

3. The plasma display device of claim 1, wherein at least a portion of the at least one ground line is coated with an insulating layer except for the ground portion.

4. The plasma display device of claim 1, wherein the at least one ground line is widest at the ground portion.

5. The plasma display device of claim 1, wherein the ground portion is arranged at a central portion of the signal transferring unit.

6. The plasma display device of claim 1, wherein the ground portion is arranged at an edge of the signal transferring unit.

7. The plasma display device of claim 1, wherein the ground portion is attached to the frame by a conductive adhesive.

8. The plasma display device of claim 1, wherein the frame is conductive and comprises a protrusion in a region that substantially contacts with the ground portion.

9. A plasma display device, comprising:
a panel displaying an image;
a frame supporting the panel;
a driving unit coupled with the frame to generate electrical signals for driving the panel;
a signal transferring unit comprising at least one signal transferring line for transferring electrical signals between the driving unit and the panel, and at least one ground line having a ground portion substantially contacting with the frame, the at least one ground line connected with the driving unit; and
a fixing member that fixes the ground portion such that the ground portion is substantially contacted with the frame.

10. The plasma display device of claim 9, wherein the fixing member comprises a cover part that covers at least a part of the ground portion, and a connecting part that extends from the cover part and is coupled with the frame.

11. The plasma display device of claim 10, wherein the cover part and the connecting part are conductive, and the cover part substantially contacts with the ground portion.

12. The plasma display device of claim 10, wherein the cover part presses the ground portion such that the ground portion substantially contacts with the frame.

13. The plasma display device of claim 10, wherein the connecting part is coupled with a protrusion from the frame, the protrusion being formed on the frame as one body.

14. The plasma display device of claim 13, wherein the protrusion is a separate member that is connected to the frame.

15. The plasma display device of claim 9, wherein the fixing member passes through the signal transferring unit, and the ground portion substantially contacts with the frame.

16. The plasma display device of claim 15, wherein the fixing member is located in a region where the at least one signal transferring line does not exist.

17. The plasma display device of claim 15, wherein the fixing member is conductive and passes through the ground portion.

18. A plasma display device, comprising:
a panel displaying an image;
a frame supporting the panel;
a driving unit coupled with the frame to generate electrical signals for driving the panel;
a signal transferring unit comprising at least one signal transferring line for transferring electrical signals between the driving unit and the panel, and at least one ground line having a ground portion substantially contacting with the frame, the at least one ground line connected with the driving unit;
a cover plate covering at least a part of the ground portion; and
a first fixing member passing through the cover plate and connected to the frame, such that the ground portion is substantially contacted with the frame.

19. The plasma display device of claim 18, wherein the cover plate and the first fixing member are conductive, and the cover plate is substantially contacted with the ground portion.

20. The plasma display device of claim 19, wherein the cover plate presses the ground portion such that the cover plate is substantially contacted with the ground portion.

21. The plasma display device of claim 19, wherein the ground portion is attached to the cover plate by a conductive adhesive.

22. The plasma display device of claim 18, wherein signal transferring unit further comprises an integrated circuit chip coupled with the at least one signal transferring line to control transfer of the electrical signals between the driving unit and the panel, and
wherein the cover plate covers the integrated circuit chip.

23. The plasma display device of claim 22, wherein the cover plate covers an edge of the frame.

24. The plasma display device of claim 18, further comprising a supporting plate arranged between the signal transferring unit and the frame and at a place corresponding to the ground portion.

25. The plasma display device of claim 24, wherein the supporting plate is coupled with the frame by a second fixing member.

26. The plasma display device of claim 24, wherein the first fixing member is conductive and fixes the supporting plate to the frame.

27. The plasma display device of claim 18, wherein an outer surface of the first fixing member comprises a thread corresponding to a thread formed in a hole in the frame.

28. The plasma display device of claim 18, wherein the first fixing member is coupled with a protrusion from the frame, the protrusion being formed on the frame as one body.

29. The plasma display device of claim 28, wherein the protrusion is a separate member that is connected to the frame.

30. A plasma display device, comprising:
a panel displaying an image;
a frame supporting the panel;
a driving unit coupled with the frame to generate electrical signals for driving the panel;
a signal transferring unit comprising at least one signal transferring line for transferring electrical signals between the driving unit and the panel, and at least one ground line having a ground portion substantially contacting with the frame, the at least one ground line connected with the driving unit; and
a cover plate covering at least a part of the ground portion so as to substantially contact the ground portion with the frame.

31. The plasma display device of claim 30, wherein the cover plate is conductive and is coupled with the frame, and the ground portion substantially contacts with the cover plate.

32. The plasma display device of claim 31, wherein the ground portion is closely contacted with the cover plate.

33. The plasma display device of claim 30, wherein the cover plate presses the ground portion such that the ground portion is substantially contacted with the frame.

34. The plasma display device of claim 33, wherein the cover plate is conductive and substantially contacted with the ground portion.

35. The plasma display device of claim 30, further comprising:
a heat sink plate covering the cover plate and the signal transferring unit.

36. The plasma display device of claim 35, wherein the cover plate and the heat sink plate are conductive and are electrically connected together, the heat sink plate is connected to the frame, and the ground portion substantially contacts with the cover plate.

37. The plasma display device of claim 36, wherein the heat sink plate is connected to the frame by a conductive fixing member.

38. A signal transferring unit for a display device, comprising:
at least one signal transferring line; and
at least one ground line,
wherein the at least one signal transferring line transfers electrical signals between a driving unit and a display panel, and
wherein the at least one ground line comprises a ground portion that substantially contacts a frame that supports the display device.
